(19) United States
(12) Patent Application Publication
(10) Pub. No.: US 2019/0221376 A1
(43) Pub. Date: Jul. 18, 2019

(54) SEALS FOR HOLES IN SOLAR CELLS

(71) Applicant: 3GSOLAR PHOTOVOLTAICS LTD., Jerusalem (IL)

(72) Inventors: Nir STEIN, Karkur (IL); Izhak BARZILAY, Ramat Yishai (IL); Barry BREEN, Givat-Zeev (IL); Jonathan GOLDSTEIN, Jerusalem (IL)

(21) Appl. No.: 16/312,043

(22) PCT Filed: Jun. 21, 2017
(86) PCT No.: PCT/IB2017/053718

§ 371 Date: Dec. 20, 2018

(30) Foreign Application Priority Data
Jun. 21, 2016 (GB) 1610841.7

(51) Int. Cl. H01G 9/20

(52) U.S. Cl. CPC H01G 9/2077

(57) ABSTRACT

A solar cell having a fill hole sealed by a spherical plug and at least one curable sealant layer.

### FIELD OF THE INVENTION

The present invention relates to solar cells and, more particularly, to glass-walled dye solar cells having a seal in the glass wall.

### SUMMARY OF THE INVENTION

According to aspects of the present invention there is provided a photovoltaic cell including: (a) first and second photovoltaic cell walls, each having an exterior face facing an exterior environment, and an interior face, distal to the exterior face, facing an interior of the cell, at least one or both of the photovoltaic cell walls being at least partially transparent; at least one of the first and second photovoltaic cell walls having a hole passing through the exterior face and the interior face, and a surface area surrounding the hole; (b) a first, at least semi-transparent current collecting layer having a broad first face facing, and attached to, an interior face of the photovoltaic cell walls, and a broad second face, distal to the first face; (c) a porous support layer, attached to the first current collecting layer; (d) at least one light harvesting species, directly attached to, and supported by, the porous support layer, the light harvesting species and the porous support layer adapted to convert photons to electrons; (e) a second current collecting layer, disposed between the porous support layer and the second photovoltaic cell wall, and attached to the second photovoltaic cell wall; (f) a sealing arrangement, disposed within the hole; the sealing arrangement including: (i) a solid, monolithic plug; and (ii) at least one curable sealant layer bonded to the plug, such that a full cross-section of the hole, parallel with respect to the exterior face, is filled and fluidly sealed by (i) and (ii).

According to aspects of the present invention there is provided a photovoltaic cell comprising: (a) first and second photovoltaic cell walls, each having an exterior face facing an exterior environment, and an interior face, distal to the exterior face, facing an interior of the cell, at least one of the photovoltaic cell walls being at least partially transparent; at least one of the first and second photovoltaic cell walls having a hole passing through the exterior face and the interior face, wherein the hole is surrounded by a hole surface area; (b) a first, at least semi-transparent current collecting layer having a broad first face facing, and attached to, an interior face of at least one, and optionally both of the photovoltaic cell walls, and a broad second face, distal to the first face; (c) a porous support layer, attached to the first current collecting layer; (d) at least one light harvesting species, directly attached to, and supported by, the porous support layer, the light harvesting species and the porous support layer adapted to convert photons to electrons; (e) a second current collecting layer, disposed between the porous support layer and the second photovoltaic cell wall, and attached to the second photovoltaic cell wall; and (f) a sealing arrangement, disposed within the hole; the hole comprising a frusto-conical portion having a wide end and a narrow end, the narrow end disposed towards or adjacent to an interior of the photovoltaic cell; the sealing arrangement including: (i) a solid, monolithic, spherical plug, at least partially disposed within the frusto-conical section, and optionally formed of glass or ceramic; and (ii) at least one curable sealant layer bonded to the solid, monolithic, spherical plug, such that a full cross-section of the hole, parallel with respect to the exterior face, is filled and fluidly sealed by a combination of the solid, monolithic, spherical plug and the at least one curable sealant layer; and wherein the curable sealant layer is dimensioned so as not to protrude past an exterior plane of the exterior face of the cell wall, in a distal direction with respect to the photovoltaic cell.

In an aspect of the present invention there is provided a method of sealing a photovoltaic cell, substantially as described herein.

In some embodiments, the plug has an exterior surface area, and wherein at least a portion of the exterior surface area of the plug contacts the at least a portion of the surface area surrounding the hole around an entire circumference thereof.

In some embodiments, at least one cross section of the hole, parallel with respect to the exterior face, is circular. In some embodiments, the plug includes a solid of revolution. In some embodiments, the solid of revolution includes at least one of a conical plug, a frusto-conical plug, a spherical plug, a cylindrical plug, an ellipsoid plug, a spheroid plug, a and torus-shaped plug. Usually, however, the plug is spherical.

In some embodiments, the plug has a circumference in the range of 0.3-6 mm. In some embodiments, the plug has a depth in the range of 0.1-2 mm. In some embodiments, the plug has a depth in the range of 20-80% of a depth of the hole.

In some embodiments, the plug is formed of glass or ceramic.

In some embodiments, the hole includes a frusto-conical hole having a first circumference at the exterior face and a second circumference at the interior face.

In some embodiments, the solid, monolithic, spherical plug has a circumference in the range of 0.25-6 mm, 0.3-6 mm, 0.5-5.5 mm, 0.8-5.5 mm, 1-5.5 mm, 1-5 mm, 1-4.5 mm, 1.5-5.5 mm, 1.5-5 mm, 1.5-4.5 mm, or 1.5-4 mm.

In some embodiments, the wide end of the hole has a first circumference in a range of 0.3-7 mm, 0.3-6 mm, 0.6-6 mm, 1-6 mm, 1-5 mm, 1.2-6 mm, 1.2-5 mm, 1.5-6 mm, 2-6 mm, 2-5 mm, 2.5-6 mm, 2.5-5 mm, or 2.5-4.5 mm.

In some embodiments, a ratio between a second circumference of the hole at the narrow end, and the first circumference, is in a range of 0.2-0.8, 0.4-0.8, 0.4-0.75, 0.4-0.7, 0.5-0.8, or 0.5-0.75.

In some embodiments, the hole includes: a first cylindrical portion having a first diameter extending from the exterior face into part of the cell wall; a second cylindrical portion having a second diameter extending from the interior face into part of the cell wall; and a shoulder disposed at a meeting point of the first cylindrical portion and the second cylindrical portion.

In some embodiments, the first diameter is greater than the second diameter. In some embodiments, the plug is sized and adapted to fit in the first cylindrical portion and to engage the shoulder. In some embodiments, the first cylindrical portion and the second cylindrical portion are concentric. In some embodiments, each of the first cylindrical portion and the second cylindrical portion has a depth in the range of 0.1-2 mm. In some embodiments, a first depth of each of the first cylindrical portion and the second cylindrical portion is in the range of 20%-80% of a depth of the hole.

In some embodiments, the hole includes: a first frusto-conical portion extending from the exterior face to a meeting point in the cell wall, and having a first diameter at the exterior face and a second diameter at the meeting point; and a second frusto-conical portion extending from the interior face to the meeting point, the second frusto-conical portion having a third diameter at the interior surface and a forth diameter at the meeting point.

In some embodiments, the first frusto-conical portion and the second are concentric. In some embodiments, the first and second frusto-conical portions are symmetrical. In some embodiments, the second diameter is different from the fourth diameter, thereby defining a shoulder connecting the first and second frusto-conical portions at the meeting point. In some embodiments, the first and second frusto-conical portions are not concentric, such that a shoulder is defined at the meeting point between the first and second frusto-conical portions. In some embodiments, the plug is sized and adapted to fit in the first frusto-conical portion and to engage the shoulder.

In some embodiments, each of the first frusto-conical portion and the second frusto-conical portion has a depth in the range of 0.1-2 mm. In some embodiments, each of a first depth of the first frusto-conical portion and a second depth of the second frusto-conical portion is in the range of 20%-80% of a depth of the hole.

In some embodiments, the hole includes: a first cylindrical portion extending from the exterior face to a meeting point in the cell wall, and having a first diameter; and a second frusto-conical portion extending from the interior face to the meeting point, the second frusto-conical portion having a second diameter at the interior surface and a third diameter at the meeting point.

In some embodiments, the cylindrical portion and the second frusto-conical portion are concentric. In some embodiments, the third diameter is different from the first diameter, thereby defining a shoulder connecting the cylindrical portion and the frusto-conical portion at the meeting point. In some embodiments, the plug is sized and adapted to fit in the cylindrical portion and to engage the shoulder. In some embodiments, the plug is sized and adapted to fit and to lodge in the frusto-conical portion.

In some embodiments, each of the cylindrical portion and the frusto-conical portion has a depth in the range of 0.1-2 mm. In some embodiments, each of a first depth of the cylindrical portion and a second depth of the frusto-conical portion is in the range of 20%-80% of a depth of the hole.

In some embodiments, a thickness of the curable sealant layer is within a range of 0.05-1 mm. In some embodiments, a thickness of the curable sealant layer is within a range of 20%-80% of a depth of the hole.

In some embodiments, the at least one curable sealant layer primarily contains a UV curable silicone-based sealant.

In some embodiments, the at least one curable sealant layer primarily contains a thermally curable and optionally fusible sealant. In some embodiments, the thermally curable sealant includes a thermally curable epoxy sealant. In some embodiments, the thermally curable sealant includes a thermally curable silicone-based sealant. In some embodiments, the thermally curable sealant has a curing temperature in the range of 60 to 100° C.

In some embodiments, the at least one curable sealant layer includes an inner curable sealant layer and an outer curable sealant layer, the outer curable sealant layer being sealed from the interior of the cell. In some embodiments, the outer curable sealant layer primarily contains an epoxy sealant and the inner curable sealant layer primarily contains a silicone-based sealant.

In some embodiments, the inner sealant layer seals between the outer sealant layer and the porous support layer, such that components of the epoxy sealant are inhibited from contacting the porous support layer.

In some embodiments, the outer curable sealant layer is disposed between the plug and the exterior face, and the inner curable sealant layer being disposed between the plug and the interior face.

In some embodiments, the outer curable sealant layer is disposed between the exterior face and the inner curable sealant layer, and the inner curable sealant layer being disposed between the outer curable sealant layer and the plug.

In some embodiments, a thickness of the outer curable sealant layer is within a range of 0.05-1 mm. In some embodiments, a thickness of the inner curable sealant layer being is a range of 0.05-1 mm. In some embodiments, a thickness of the outer curable sealant layer is within a range of 20%-80% of a depth of the hole. In some embodiments, a thickness of the inner curable sealant layer is within a range of 20%-80% of a depth of the hole.

In some embodiments, the sealing arrangement inhibits oxygen and water vapor from an environment external to the cell, from penetrating into the cell via the hole and contacting the porous support layer.

In some embodiments, a thickness of the cell wall that includes the hole is in the range of 0.3-3.2 mm.

In some embodiments, the photovoltaic cell has a minimum footprint of 0.5 cm by 2 cm, 0.5 cm by 5 cm, 1 cm by 5 cm, 5 cm by 5 cm, 7 cm by 7 cm, 10 cm by 10 cm, 12 cm by 12 cm, or 15 cm by 15 cm, and optionally, a maximum footprint of 50 cm by 50 cm or 35 cm by 35 cm.

In some embodiments, the photovoltaic cell further includes a redox species contacting the porous support layer. In some embodiments, the redox species is disposed within an electrolyte. In some embodiments, the redox species includes a copper-based redox species. In some embodiments, the redox species includes a cobalt-based redox species. In some embodiments, the redox species includes an iodine-based redox species.

In some embodiments, the light harvesting species includes a dye.

In some embodiments, the photovoltaic cell further includes a catalytic layer disposed between the porous support layer and the second current collecting layer.

In some embodiments, the photovoltaic cell further includes a cathode, disposed substantially opposite the porous support layer, wherein the cathode is attached to, and conductively communicating with, the second current collecting layer.

In some embodiments, the porous support layer contains, or primarily contains, a sintered titania. In some embodiments, the porous support layer contains, or primarily contains, sintered or unsintered alumina or titania. In some embodiments, the porous support layer has an average pore size of at least 10 nanometers, at least 15 nanometers, or at least 20 nanometers.

In some embodiments, at least one of the first and second current collecting layers includes tin oxide.

In some embodiments, the at least partially transparent cell wall is, or at least partially includes, a glass wall.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1 is a schematic cross-sectional diagram of a typical dye solar cell that may be used as a basis for the photovoltaic cell in accordance with one aspect of the present invention;

FIG. 2 is a schematic cross-sectional diagram of an inventive dye solar cell having a fill-hole sealed by a sealing arrangement in accordance with one aspect of the present invention;

FIGS. 3A, 3B, 3C, and 3D provide schematic cross-sectional diagrams of exemplary fill holes sealed by sealing arrangements in accordance with aspects of the present invention;

FIG. 3E provides a schematic cross-sectional diagram of the location of a fill hole and sealing arrangement in a small dye solar cell in accordance with aspects of the present invention;

FIG. 3F provides a schematic cross-sectional diagram of an exemplary fill hole sealed by sealing arrangements in accordance with aspects of the present invention; and

FIGS. 4A, 4B, and 4C provide schematic cross-sectional diagrams of different layer sequences of exemplary sealing arrangements in accordance with aspects of the present invention.

### DESCRIPTION OF THE PREFERRED EMBODIMENTS

Dye solar cells (DSCs) may offer a relatively inexpensive alternative to conventional silicon and thin film photovoltaic cells on the basis of materials, process costs and plant capital expenditures. While various photovoltaic systems require complex vacuum deposition processes, dye cells may be constructed using simple screenprinting of pastes followed by oven treatment in air. A general description of a dye cell following its invention by Graetzel and O'Regan in 1991 has been provided in issued U.S. Pat. No. 7,737,356 to 3GSolar Photovoltaics, Ltd., which application is hereby incorporated in entirety by reference. More recent dye cell constructions may have a nanosized mesoporous anatase titania layer stained with a sensitizing dye (the photoanode), a layer of redox electrolyte (where the redox component may be based on an iodine, copper, or cobalt species) and a catalytic cathode that often contains high surface area carbon.

To achieve superior endurance, dye cells may be sealed in glass and the titania is supported on one of the glass sheets; these sheets may be made electrically conductive by means of a thin, transparent conducting tin oxide (CTO) layer.

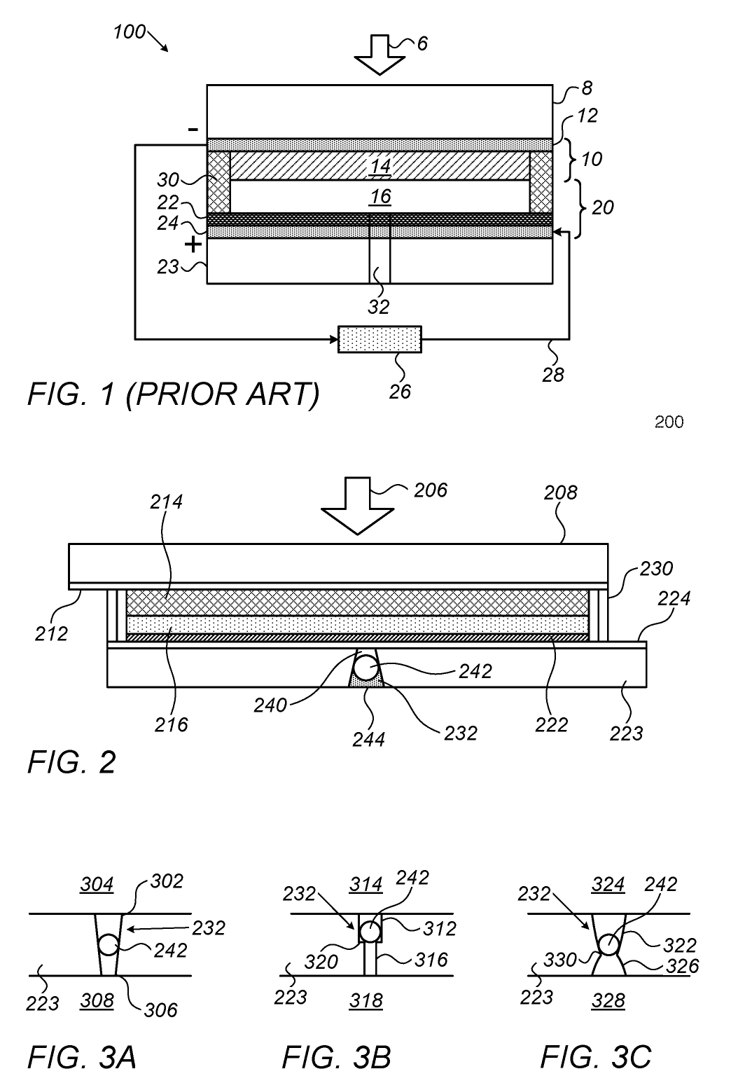

A cross-sectional schematic diagram of a typical dye solar cell 100 is provided in FIG. 1. FIG. 1 shows a photoanode 10 facing a light source 6, the photoanode including an at least semi-transparent cell wall 8 (e.g., a glass or plastic cell wall) having an at least semi-transparent or transparent conductive coating or layer 12 (e.g., a tin oxide layer or doped tin oxide layer) carrying a porous support layer (or “scaffold”) 14, typically titania, stained with sensitizing dye; a redox electrolyte (e.g., as a redox electrolyte layer 16); and a counterelectrode or cathode 20 including a catalyst layer 22 (typically made of platinum or catalytic carbon) facing photoanode 10, a cell wall 23 distal to photoanode 10, and a conductive layer 24 disposed between the catalyst layer 22 and the cell wall 23. Device 100 may supply power to a load 26 in an external circuit 28, as shown. The titania in layer 14 may include a high surface area support for the sensitizing dye. The thickness of layer 14 may typically be about 10 micrometers, and may advantageously have a sintered porous structure, the bulk density of which may be about 50% of the density of the titania crystal. Layer 14 may include, or consist largely of, nanocrystalline particles of about 20 nm in diameter.

The cell 100 further includes edge seals 30 on either side thereof, which may be effected using DuPont® Surlyn® or Bynel® films or gaskets. Such films are heat-sealed to the housing of the solar cell to form an edge seal. Alternatively, the edge seals may be dual-layer edge seals, as described in patent application number GB1518224.9 to 3GSolar Photovoltaics, Ltd., which application is hereby incorporated in entirety by reference.

In cases in which the electrolyte layer 16 is in liquid form or is initially in liquid form, construction of cell 100 involves drilling an electrolyte fill hole 32, which is approximately one mm in diameter, in one cell wall prior to cell assembly. The hole is typically drilled in wall 23 forming the non-illuminated cathode side of the cell. The cell is then assembled from the photoanode 10 including cell wall 10, conductive coating 12, and support layer 14, and the cathode 20 including catalyst layer 22, conductive layer 24, and cell wall 23, which are bonded together at the edges by edge seals 30.

Liquid suitable for forming electrolyte layer 16 is then introduced into the cell via fill hole 32, for example using vacuum means as is well known in the art, and the fill hole 32 is then sealed. The seal of fill hole 32 of cell 100 is not shown. In various dye cells of the prior art, sealing of fill hole 32 was effected by placing a small glass piece, approximately 1 cm square, over the fill hole 32, then thermally bonding the glass piece in place by a matching square piece of bonding material placed between the glass piece and the cell wall.

However, the inventors have found that such glass seals of fill-holes may have any of various deficiencies. Such seals cause the cell to be non-symmetrical. In some cases, such glass seals are prone to shearing off, as the glass piece projects approximately 1-2 mm from the broad surface of the cell which is typically approximately 4-8 mm thick, or stated differently, the glass seal increases the cell thickness by approximately 12-50%. Additionally, such glass pieces are visibly noticeable, particularly in smaller cells (e.g., having a surface area of 2 cm×5 cm), thereby contributing to an ungainly appearance of the cell.

After identifying various disadvantages of prior-art fill-hole seals, the inventors have proceeded to invent sealing technologies for sealing fill-holes including inventive sealing methods and inventive sealing constructions. The inventors have found that sealing plugs, typically having at least one circular cross-section, may advantageously seal the fill-hole from within the cell wall, without requiring any projection of the seal exterior to the cell wall. Such sealing plugs may be used for glass walls, which are at least 0.3 mm thick. Various sealants may efficaciously be used in combination with the sealing plug so as to ensure that the sealing plug does not move relative to the fill hole and that the surface of the fill-hole seal is flush with the surface of the cell wall. As disclosed in patent application number GB1518224.9 to 3GSolar Photovoltaics, Ltd., such sealants must be selected so as to avoid a deleterious effect on the chemistry of the solar cells. Specifically, silicone-based sealants may be used adjacent the electrolyte layer 16 as they are chemically inert to the electrolyte, while epoxy-based sealants must be separated from contact with the electrolyte (or the vapor thereof) so as not to chemically interact therewith. Both silicone-based sealants and epoxy-based sealants belong to the class of thermosetting materials. Additionally, the seal can incorporate thermoplastic components such as DuPont® Surlyn® or Bynel® from films, gaskets or granules, which materials form stable seals in contact with the cell electrolyte.

In accordance with one aspect of the present invention, FIG. 2 provides a schematic cross-sectional diagram of an inventive dye solar cell 200 having a fill-hole 232 sealed by a sealing arrangement 240 including a sealing plug 242. The basic structure of sealed dye solar cell 200 may be substantially identical to that of cell 100 and includes a photoanode facing a light source 206, the photoanode including an at least semi-transparent cell wall 208 having an at least semi-transparent or transparent conductive coating or layer 212 carrying a porous support layer 214, typically titania, stained with sensitizing dye; a redox electrolyte (e.g., as a redox electrolyte layer 216); and a counterelectrode or cathode including a catalyst layer 222 facing the photoanode, a cell wall 223 distal to the photoanode and including a fill hole 232, and a conductive layer 224 disposed between the catalyst layer 222 and the cell wall 223; and edge seals 230 sealing the sides of the cells, all substantially as described hereinabove with reference to FIG. 1.

In some embodiments, cell wall 223 has a thickness in the range of 0.3 mm-3.2 mm.

The fill hole 232 typically has a circular cross section along the plane parallel to that of the cell wall, and in some embodiments has a diameter in the range of 0.1 mm-2 mm. A sealing plug 242, which in some embodiments is a solid monolithic plug, has, at at least one portion thereof, a circular cross section having a circumference corresponding in size to the circular cross section of fill-hole 232, such that at the contact point the plug contacts the glass wall of the fill hole around 360 degrees of the circumference of the fill hole, and the hole is filled thereby. In some embodiments, as explained in further detail hereinbelow, the plug 242 is sized to lodge at approximately half the depth of fill hole 232.

It will be appreciated that in embodiments in which the fill hole 232 does not have a circular cross section, but rather a cross section of a different shape, the sealing plug 242 is designed to have a cross section corresponding to that of the fill hole 232, such that at a contact point the plug contacts the glass wall of the fill hole around the entire circumference thereof, thereby to fill the hole.

In some embodiments, the plug has a circumference in the range of 0.3 mm-6 mm. In some embodiments, the plug has a depth, or thickness, in the range of 0.1 mm-2 mm, or in the range of 20%-80% of the depth of the fill hole.

The sealing plug 242 may be formed of any suitable material, such as, for example, glass or ceramic. The sealing plug 242 may be of any suitable shape having at least one suitably sized and shaped cross section. For example, when the fill hole 232 has a circular cross section, sealing plug 242 may be a cylindrical plug, a conical plug, a frusto-conical plug, a spherical plug, an ellipsoid plug, a spheroid plug, a torus-shaped plug, or a plug shaped like any other solid of revolution.

Sealing arrangement 240 further includes at least one curable sealant layer 244, which seals plug 242 in its place and ensures sealing of fill-hole 232 to the environment exterior to the cell 200, as described in further detail hereinbelow with reference to FIGS. 4A to 4C. The at least one curable sealant layer is designed and configured to inhibit oxygen and water vapor from an environment external to the cell, from penetrating into the cell and contacting the porous support layer 214. The sealing arrangement 240 is designed and configured to prevent cell electrolyte from leaking from the cell, otherwise leaving the cell, and/or to prevent external impurities (air, moisture) entering the cell.

In some embodiments, the sealant layer 244 has a thickness in the range of 0.1 mm-1.5 mm or in the range of 20%-80% of the depth of fill-hole 232. In some embodiments, the sealant layer 244 comprises a sealant having a curing time in the range of seconds to minutes.

As described in further detail hereinbelow with reference to FIGS. 4A to 4C, in some embodiments the sealing arrangement includes two or more sealant layers of different types.

In some embodiments, conductive layer 224 and catalyst layer 222 (shown disposed adjacently thereto) may be a single conductive layer, e.g., a platinum layer.

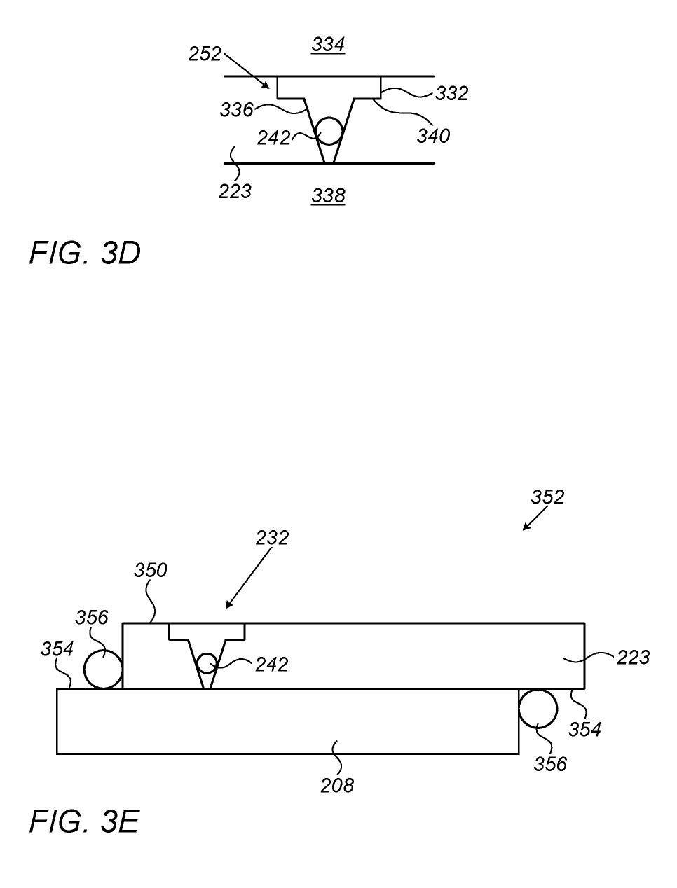

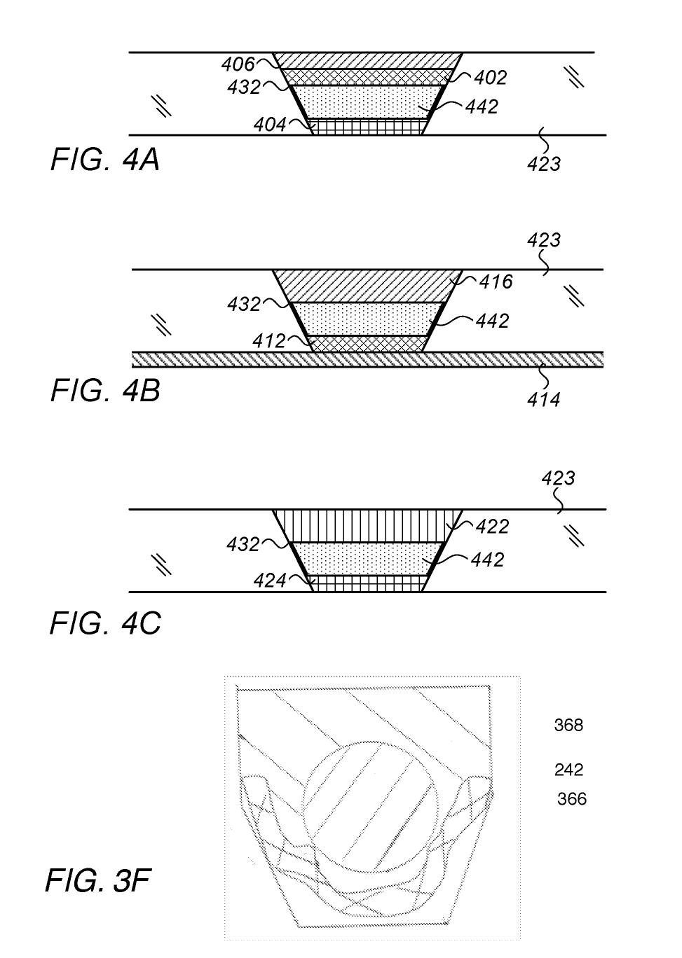

Reference is now made to FIGS. 3A, 3B, 3C, and 3D which provide schematic cross-sectional diagrams of exemplary fill holes sealed by sealing arrangements in accordance with aspects of the present invention. As seen in FIGS. 3A, 3B, and 3C, the fill hole 232 need not necessarily be cylindrical, or have a single circular cross section or a uniform circular cross section.

In some embodiments, as seen in FIG. 3A, fill-hole 232 formed in cell wall 223 comprises a frusto-conical hole, having a first, larger circumference 302 adjacent a surface of cell wall 223 facing the exterior of the cell indicated by reference numeral 304, and a second, smaller circumference 306 adjacent a surface of cell wall 223 facing towards the interior of the cell indicated by reference numeral 308. In such embodiments, plug 242 is typically designed to have a circumference corresponding to the circumference of fill hole 232 at a center thereof, such that the plug lodges in or around the center of the fill hole 232. However, it is appreciated that any plug having a circumference smaller than the first circumference and greater than the second circumference of the fill hole would be suitable for plugging the fill hole, and would lodge at a portion of the fill-hole having a corresponding diameter. In the embodiment of FIG. 3A, the plug 242 may be lodged in place, and prevented from motion toward the interior of the cell by the smaller circumference of the fill hole adjacent the interior of the cell, and may be prevented from exiting the cell by at least one layer of sealant, as described herein below with reference to FIGS. 4A to 4C.

In some embodiments, the first circumference 302 is in the range of 0.3 mm-6 mm, and the second circumference 306 is in the range of 0.2 mm-4 mm. In some embodiments, a ratio between the second circumference 306 and the first circumference 302 is in the range of 0.2-0.8.

Turning to FIG. 3B, It is seen that in some exemplary embodiments, fill-hole 232 comprises a first generally cylindrical hole portion 312 having a first, larger circumference and extending from a surface of cell wall 223 facing the exterior of the cell indicated by reference numeral 314 part of the way into the cell wall 223, and a second generally cylindrical hole portion 316 having a second circumference, smaller than that of first hole portion 312, and extends from a surface of cell wall 223 facing towards the interior of the cell indicated by reference numeral 318 into cell wall 223, such that a meeting point between cylindrical hole portion 312 and cylindrical hole portion 316 defines a shoulder 320. In such embodiments, plug 242 is typically designed to have a circumference corresponding to the circumference of first cylindrical hole portion 312, such that when the plug is inserted into fill hole 232 it may be pushed in to engage shoulder 320, such that shoulder 320 prevents the plug 242 from moving toward the interior of the cell. The plug 242 may be bonded in place, and prevented from exiting the cell, by at least one layer of sealant, as described herein below with reference to FIGS. 4A to 4C.

In some embodiments, such as the illustrated embodiment, the first cylindrical portion 312 and the second cylindrical portion 316 are concentric. However, in other embodiments (not illustrated), the first cylindrical portion 312 and the second cylindrical portion 316 may not be concentric.

In some embodiments, the first cylindrical portion 312 has a depth in the range of 0.1 mm-2 mm. In some embodiments, the second cylindrical portion 316 has a depth in the range of 0.1 mm-2 mm. In some embodiments, a depth of the first cylindrical portion 312 is in the range of 20%-80% of a depth of the fill hole 232. In some embodiments, a depth of the second cylindrical portion 316 is in the range of 20%-80% of a depth of the fill hole 232.

Turning to FIG. 3C, It is seen that in some exemplary embodiments, fill-hole 232 comprises a first frusto-conical hole portion 322 extending from a surface of cell wall 223 facing the exterior of the cell indicated by reference numeral 324 part of the way into the cell wall 223, the first hole portion 322 having an exterior diameter at the exterior face of the cell wall and a first center diameter within the cell wall, and a second frusto-conical hole portion 326 which extends from a surface of cell wall 223 facing towards the interior of the cell indicated by reference numeral 328 into cell wall 223, the second hole portion 326 having an interior diameter at the interior face of the cell wall and a second center diameter within the cell wall.

In some embodiments, such as that illustrated in FIG. 3C, the first and second frusto-conical portions 322 and 326 are symmetrical and concentric, and define a meeting point therebetween indicated by reference numeral 330. In such embodiments, plug 242 is typically designed to have a circumference greater than the circumference of narrowest point 330, such that when the plug is inserted into fill hole 232 it may be lodged in place in first frusto-conical portion 322, and thus prevent from motion toward the interior of the cell. The plug 242 may be bonded in place, and prevented from exiting the cell or from entering into the interior of the cell by at least one layer of sealant, as described herein below with reference to FIGS. 4A to 4C.

In some embodiments, the first center diameter is different in size from the second center diameter, thereby forming a shoulder at the meeting point between the first center diameter and the second center diameter, similar to the shoulder 320 of FIG. 3B. In other embodiments, the first and second frusto-conical portions 322 and 326 are not concentric, such that a shoulder is formed therebetween, and the circumference of the fill-hole at meeting point 330 is smaller than any circumference of either of first and second frusto-conical portions 322 and 326. In embodiments in which the fill hole 232 defines a shoulder, plug 242 is typically designed to have a circumference corresponding to the circumference of first frusto-conical hole portion 322 at the center of the cell wall, such that when the plug is inserted into fill hole 232 it may be pushed in to engage the shoulder, such that shoulder prevents the plug 242 from moving toward the interior of the cell. The plug 242 may be bonded in place, and prevented from exiting the cell, by at least one layer of sealant, as described herein below with reference to FIGS. 4A to 4C. It is appreciated that the exterior diameter of the first frusto-conical portion and the interior diameter of the second frusto-conical portion may be equal, or may be different, depending on the application and use of the cell and on the structure of the cell wall.

In some embodiments, the first frusto-conical portion 322 has a depth in the range of 0.1 mm-2 mm. In some embodiments, the second frusto-conical portion 326 has a depth in the range of 0.1 mm-2 mm. In some embodiments, a depth of the first frusto-conical portion 322 is in the range of 20%-80% of a depth of the fill hole 232. In some embodiments, a depth of the second frusto-conical portion 326 is in the range of 20%-80% of a depth of the fill hole 232.

Turning to the exemplary embodiment of FIG. 3D, it is seen that fill-hole 232 may have a cylindrical hole portion 332 having a cylindrical portion diameter and extending from a surface of cell wall 223 facing the exterior of the cell indicated by reference numeral 334 part of the way into the cell wall 223, and a frusto-conical hole portion 336 which extends from a surface of cell wall 223 facing towards the interior of the cell indicated by reference numeral 338 into cell wall 223, the second hole portion 336 having an interior diameter at the interior face of the cell wall and a center diameter within the cell wall.

In some embodiments, such as that illustrated in FIG. 3D, the cylindrical and frusto-conical portions 332 and 336 are concentric, and the cylindrical portion diameter is greater than the center diameter of the frusto-conical portion, such that a shoulder 340 is defined at the meeting point between the two portions. In some such embodiments, plug 242 is typically designed to have a circumference greater than the interior circumference of the frusto-conical portion, but smaller than the center circumference, such that plug 242 lodges in place in the frusto-conical portion 336, and is thus prevented from moving toward the interior of the cell. The plug 242 may be bonded in place, and prevented from exiting the cell or from entering into the interior of the cell by at least one layer of sealant, as described herein below with reference to FIGS. 4A to 4C. In other embodiments, not illustrated, the circumference of plug 242 may be greater than the center circumference, but smaller than the circumference of the cylindrical portion, such that the plug would engage shoulder 340, substantially as described hereinabove with reference to FIG. 3B.

In some embodiments, the cylindrical and frusto-conical portions 332 and 336 are not concentric.

In some embodiments, the cylindrical portion 332 has a depth in the range of 0.1 mm-2 mm. In some embodiments, the frusto-conical portion 336 has a depth in the range of 0.1 mm-2 mm. In some embodiments, a depth of the cylindrical portion 332 is in the range of 20%-80% of a depth of the fill hole 232. In some embodiments, a depth of the frusto-conical portion 336 is in the range of 20%-80% of a depth of the fill hole 232.

Reference is now made to FIG. 3E, which provides a schematic cross-sectional diagram of the location of a fill hole and sealing arrangement in a small dye solar cell in accordance with aspects of the present invention. As seen in FIG. 3E, a fill hole 232 having a sealing plug 242 therein may be disposed in a corner 350 of a small dye solar cell 352, for example sized 38 mm×36 mm and having walls 208 and 223 that are each 2.2 mm thick. As seen, the cell walls 208 and 223 are not aligned with one another such that a shoulder 354 is formed on either side of cell 352. Cylindrical current takeoff wires 356 are disposed longitudinally along shoulders 354.

FIG. 3F provides a schematic cross-sectional diagram of an exemplary fill hole sealed by a spherical, monolithic, solid plug 242 having a sealing layer or film 366 disposed generally underneath plug 242, and a sealant layer 368 disposed generally above plug 242. Film 366, which may be made of any of the sealant materials provided herein, may advantageously be a silicone sealant film such as Surlyn® or Bynel®. Sealant layer 368 may be made of any of the sealant materials provided herein. In some embodiments, sealant layer 368 is, or includes, epoxy sealant.

Reference is now made to FIGS. 4A, 4B, and 4C, which provide schematic cross-sectional diagrams of different layer sequences of exemplary sealing arrangements in accordance with aspects of the present invention.

As seen in FIG. 4A, in some embodiments, sealing of a fill hole 432 in a cell wall 423 is effected by inserting therein a plug 442, substantially as described hereinabove with reference to FIG. 2. A layer of thermally curable silicone sealant 402, which is chemically inert to interaction with the cell electrolyte that may enter any free space left below the cured silicone in the fill hole in the cell (this electrolyte indicated by reference numeral 404), is applied onto the plug. A layer of thermally curable epoxy sealant 406 is applied above the curable silicone sealant 402, and is set to be flush with the surface of cell wall 423 and not to protrude therefrom. In such embodiments, the electrolyte layer 404 is separated from the epoxy sealant layer 406 by plug 442 and silicone sealant layer 402, thereby preventing deleterious chemical interaction between the electrolyte layer 404 and the epoxy sealant layer 406. Following introduction of heat to the fill hole and curing of the sealants therein, the plug 442 bonds to the silicone sealant 402, and thus cannot move out of its place within the fill hole.

Various epoxy sealants are known in the art and/or are commercially available and may be suitable for use in curable epoxy sealant layer 406. Potentially suitable epoxy sealants include EPO-TEK® 301, 330, 350ND, 730, 920, E2001, E3026, EJ2189, H74, OE121, OM125, and TV2001.

Various silicone and silicone-based sealants are known in the art and/or are commercially available and may be suitable for use in curable silicone sealant layer 402. Potentially suitable silicone-based sealants include Dow Corning® 121, 700, SE1720, 7091, 786, 995, HM2520, Molykote® 111 and Molykote® 316. Of course, one of ordinary skill in the art will appreciate that similar or substantially equivalent sealants may be available from other manufacturers and suppliers.

In some embodiments, a thickness of the silicone sealant layer 402 may be within a range of 0.05 mm-1 mm, or within the range of 20%-80% of the depth of fill hole 432.

In some embodiments, a thickness of the epoxy sealant layer 402 may be within a range of 0.05 mm-1 mm, or within the range of 20%-80% of the depth of fill hole 432.

In some embodiments, the thickness of plug 442 may be within a range of 0.1 mm-2 mm, or within the range of 20%-80% of the depth of fill hole 432.

In some embodiments, the thermally curable epoxy sealant layer 402 and the thermally curable silicone-based sealant layer 406 have a curing temperature of at most 100, at most 90, at most 80, at most 70, or at most 60 degrees Celsius. In some embodiments, the thermally curable epoxy sealant layer 402 and the thermally curable silicone-based sealant layer 406 have a curing temperature in the range of 60-100 degrees Celsius. In some embodiments, the thermally curable epoxy sealant layer 402 and the thermally curable silicone-based sealant layer 406 have a curing temperature in the range of 60-100 degrees Celsius.

Turning now to FIG. 4B, it is seen that in some embodiments, sealing of a fill hole 432 in a cell wall 423 is effected by initially applying a layer of thermally curable silicone sealant 412, which is chemically inert to interaction with the cell electrolyte 414 that may enter any free space left below the cured silicone in the fill hole in the cell, to the base of fill hole 432. Plug 442 is then inserted into the fill hole 432 so that the plug 442 is in full contact with the silicone sealant layer 412 and engages a full circumference of the fill hole, substantially as described hereinabove with reference to FIG. 2.

In some embodiments, a film and/or powder of Surlyn® or Bynel® may be disposed below the plug instead of silicone. This Surlyn® or Bynel® layer is fusible, and may be fused into place below the plug by applying heat to the plug from above, for example using a flat head welder for a short period of approximately one minute, such that the Surlyn® or Bynel® material is fused at a temperature of around 180° C., so as to sealably bond to the plug surface and to the circumference of the fill hole.

A layer of thermally curable epoxy sealant 416 or DuPont® Surlyn® is then applied above the plug 442, and is set to be flush with the surface of cell wall 423 and not to protrude therefrom. In such embodiments, the electrolyte layer 414 only engages the silicone sealant layer 412 (or the Surlyn® or Bynel® layer if that is used in place of silicone) which is inert thereto, and is separated from the epoxy sealant layer 416 by plug 442 and silicone sealant layer 412, thereby preventing deleterious chemical interaction between the electrolyte layer 414 and the epoxy sealant layer 416.

Various suitable epoxy sealants may be used in epoxy sealant layer 416 and various silicone and silicone-based sealants may be used in curable silicone sealant layer 412, substantially as described hereinabove with respect to FIG. 4A.

In some embodiments, a thickness of the silicone sealant layer 402 may be within a range of 0.05 mm-1 mm, or within the range of 20%-80% of the depth of fill hole 432.

In some embodiments, a thickness of the epoxy sealant layer 402 may be within a range of 0.05 mm-1 mm, or within the range of 20%-80% of the depth of fill hole 432.

In some embodiments, the thickness of plug 442 may be within a range of 0.1 mm-2 mm, or within the range of 20%-80% of the depth of fill hole 432.

Sealing materials suitable for use in accordance with the present invention for example as described with respect to FIGS. 4A and 4B, and more specifically, such suitable epoxy and silicone-based materials, may advantageously have the following properties:
fast curing (typically minutes to hours);
low temperature curing (typically below about 80° C.); and
low evolution of curing by-products (particularly any that might deleteriously affect the chemistry of the solar cell).

Referring now to FIG. 4C, in some embodiments, sealing of a fill hole 432 in a cell wall 423 is effected by inserting thereinto a plug 442, substantially as described hereinabove with reference to FIG. 2. A layer of ultraviolet light (UV) curable silicone sealant 422, which is chemically inert to interaction with the cell electrolyte that may partially enter any free space left below the cured silicone in the fill hole in the cell (this electrolyte indicated by reference numeral 424), is applied onto the plug and is bonded thereto. The sealant layer 422 is set to be flush with the surface of cell wall 423 and not to protrude therefrom. It will be appreciated by people skilled in the art that use of a UV curable silicone sealant allows for shorter curing times, which may be advantageous in certain settings.

Various UV curable silicone or silicone-based sealants are known in the art and/or are commercially available and may be suitable for use in sealant layer 422. Potentially suitable UV curable silicone-based sealants include RTV210A and UV2500. Of course, one of ordinary skill in the art will appreciate that similar or substantially equivalent sealants may be available from other manufacturers and suppliers.

In some embodiments, a thickness of the silicone sealant layer 422 may be within a range of 0.05 mm-1 mm, or within the range of 20%-80% of the depth of fill hole 432.

In some embodiments, the thickness of plug 442 may be within a range of 0.1 mm-2 mm, or within the range of 20%-80% of the depth of fill hole 432.

It is appreciated that though the dye solar cell structure and method of sealing described hereinabove are described with respect to, and useful for, dye solar cells with a liquid electrolyte, the method of construction can be adapted to any solar cell where components may be added or removed via a fill hole prior to sealing.

For example, the method may be adapted for use in a dye solar cell having a solid phase electrolyte. The basic structure of a solid-electrolyte based solar cell is known to those of skill in the art, and is disclosed in an article by Lee et al., “Efficient Hybrid Solar Cells Based on Meso-Superstructured Organometal Halide Perovskites” (Science, 4 Oct. 2012), which article is incorporated by reference for all purposes, as if fully disclosed herein. In solid-electrolyte based solar cells, the electrolyte may be dissolved in a liquid solvent and introduced into the cell as a solution via a fill hole, and then the solvent may be evaporated from the dye solar cell before sealing of the fill hole, substantially as described hereinabove.

### EXAMPLES

Reference is now made to the following examples, which together with the above description, illustrate the invention in a non-limiting fashion.

### Example 1

An anode cell wall having dimensions of 20 mm×50 mm×2.2 mm and comprising a layer of conducting glass coated with a layer of fluorinated tin oxide (FTO) was covered with a printed, sintered, 10 micron thick layer of porous titania, leaving a 2 mm wide perimeter clear for subsequent edge sealing. The titania layer was stained by immersion thereof in a solution of a N719 ruthenium sensitizing dye (of Solaronix of Switzerland) and was subsequently dried.

A cathode cell wall having dimensions identical to those of the anode cell wall was constructed of FTO coated glass, and was drilled at the center of its large face with a conical drill such that the drill hole on the outer side of the glass, not coated with FTO, had a diameter of 1.5 mm, and the drill hole on the inner (FTO) side of the glass had a diameter of 1 mm, thereby forming a fill hole. The FTO side of the glass was then catalyzed with trace platinum by painting on and sintering a Platisol solution (of Solaronix of Switzerland) leaving a 2 mm wide perimeter clear for subsequent edge sealing.

A 1 mm wide layer of silicone adhesive (7091 of Dow Corning®) was applied to the cathode cell wall all around the perimeter on the FTO side thereof, and a contiguous 1 mm wide layer of epoxy (330 of Epotek®) was applied to the perimeter surrounding the layer of silicone adhesive. The anode cell wall was laid symmetrically on the cathode cell wall such that the 2 mm wide perimeter of the anode cell wall contacted the adhesives, leaving 2 mm glass projecting at each long side for power takeoff from the cell. Thermal curing of the silicone and epoxy edge adhesives was then completed at 80 degrees C. for 30 minutes.

Following curing of the adhesive layers, electrolyte (HSE type of Dyesol, Australia) was then introduced into the cell via the fill hole using vacuum, according to common practice.

To seal the fill hole, a glass ball having a diameter of 1.2 mm was inserted into the fill hole, and a layer of UV curable adhesive (UV25 of MasterBond®) was injected above the ball, in an amount such that following curing thereof the adhesive would be slightly submerged or flush with respect to the outer cell wall. The adhesive was then cured under UV light of wavelength 350 nm irradiating at 30 mW/sq cm for 20 seconds. In use, the cell showed acceptable performance and durability, with no electrolyte leakage.

### Example 2

Two cells similar to the cell of example 1 were prepared with a different fill hole configuration, comprising an outer cylindrical section of diameter 1.7 mm and depth 0.7 mm and an inner frusto-conical section of upper diameter 1.7 mm, lower diameter 0.8 mm and depth 1.5 mm.

Electrolyte was introduced into each of the cells via the fill hole by means of a vacuum, according to common practice. The holes were sealed, as described hereinbelow.

In order to seal the first cell, a Dupont® Surlyn® film having a thickness of 60 microns was tamped into the cylindrical part of the fill hole and a glass ball of diameter 0.9 mm was pushed down firmly into the frusto-conical section of the fill hole. The glass ball was heated by means of a 1 mm diameter flat head welder set at 180° C. for 1 minute to melt the Surlyn® film, and subsequently an epoxy layer (Epotek® 330) was applied above the glass ball and cured at 80 degrees Celsius for 30 minutes.

In the second cell, a 0.9 mm diameter glass ball was tamped into the frusto-conical section of the fill hole and covered with Dupont® Surlyn® film and/or Dupont® Surlyn® powder. Heat was applied to the glass ball and Surlyn® using a flat head welder set at 180° C. for 1 minute to melt the Surlyn®, as was done for the first cell. Excess Surlyn® in the cylindrical portion of the fill hole was removed by gentle drilling with a Dremel drill fitted with a 1.5 mm diameter bit. The drilling procedure also roughened the upper surface of the glass ball. Subsequently, an epoxy layer (Epotek® 330) was applied above the Surlyn® layer, and was cured at 80 degrees Celsius for 30 minutes.

Both cells showed acceptable performance and durability, with no electrolyte leakage.

As used herein in the specification and in the claims section that follows, the term “sintered”, “undergone sintering”, and the like, with respect to a cell component, is meant to include both low-temperature sintering and high-temperature sintering.

As used herein in the specification and in the claims section that follows, the term “primarily containing” is used to mean containing at least 50%, by at least one of volume and weight.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification, including U.S. Pat. No. 7,737,356, are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A photovoltaic cell comprising:
(a) first and second photovoltaic cell walls, each having an exterior face facing an exterior environment, and an interior face, distal to said exterior face, facing an interior of the cell, at least one of said photovoltaic cell walls being at least partially transparent; at least one of said first and second photovoltaic cell walls having a hole passing through said exterior face and said interior face, wherein said hole is surrounded by a hole surface area;
(b) a first, at least semi-transparent current collecting layer having a broad first face facing, and attached to, an interior face of at least one, and optionally both of said photovoltaic cell walls, and a broad second face, distal to said first face;
(c) a porous support layer, attached to said first current collecting layer;
(d) at least one light harvesting species, directly attached to, and supported by, said porous support layer, said light harvesting species and said porous support layer adapted to convert photons to electrons;
(e) a second current collecting layer, disposed between said porous support layer and said second photovoltaic cell wall, and attached to said second photovoltaic cell wall; and
(f) a sealing arrangement, disposed within said hole;
said hole comprising a frusto-conical portion having a wide end and a narrow end, said narrow end disposed towards or adjacent to an interior of the photovoltaic cell;
said sealing arrangement including:
(i) a solid, monolithic, spherical plug, at least partially disposed within said frusto-conical section, and optionally formed of glass or ceramic;
and
(ii) at least one curable sealant layer bonded to said solid, monolithic, spherical plug, such that a full cross-section of said hole, parallel with respect to said exterior face, is filled and fluidly sealed by a combination of said solid, monolithic, spherical plug and said at least one curable sealant layer;
and wherein said curable sealant layer is dimensioned so as not to protrude past an exterior plane of said exterior face of said cell wall, in a distal direction with respect to the photovoltaic cell.

2. The photovoltaic cell of claim 1, wherein said sealing arrangement is dimensioned so as not protrude into said interior of the photovoltaic cell.

3. The photovoltaic cell of claim 1 or claim 2, wherein said solid, monolithic, spherical plug has an exterior surface area, and wherein at least a portion of said exterior surface area of said solid, monolithic, spherical plug contacts said at least a portion of said hole surface area surrounding said hole, around an entire circumference thereof.

4. The photovoltaic cell of any one of claims 1 to 3, wherein said solid, monolithic, spherical plug has a circumference in the range of 0.25-6 mm, 0.3-6 mm, 0.5-5.5 mm, 0.8-5.5 mm, 1-5.5 mm, 1-5 mm, 1-4.5 mm, 1.5-5.5 mm, 1.5-5 mm, 1.5-4.5 mm, or 1.5-4 mm.

5. The photovoltaic cell of any one of claims 1 to 4, wherein said wide end of said hole has a first circumference in a range of 0.3-7 mm, 0.3-6 mm, 0.6-6 mm, 1-6 mm, 1-5 mm, 1.2-6 mm, 1.2-5 mm, 1.5-6 mm, 2-6 mm, 2-5 mm, 2.5-6 mm, 2.5-5 mm, or 2.5-4.5 mm.

6. The photovoltaic cell of any one of claims 1 to 5, wherein a ratio between a second circumference of said hole at said narrow end, and said first circumference, is in the range of 0.2-0.8, 0.4-0.8, 0.4-0.75, 0.4-0.7, 0.5-0.8, or 0.5-0.75.

7. The photovoltaic cell of any one of claims 1 to 6, wherein said hole comprises:
a cylindrical portion extending from said exterior face to a meeting point in said cell wall, and having a first diameter; and said frusto-conical portion,
said frusto-conical portion extending from said interior face to said meeting point, said frusto-conical portion having a second diameter at said interior surface and a third diameter at said meeting point.

8. The photovoltaic cell of claim 7, wherein said first cylindrical portion and said second frusto-conical portion are concentric.

9. The photovoltaic cell of claim 8, wherein said third diameter is different from said first diameter, thereby defining a shoulder connecting said cylindrical portion and said frusto-conical portion at said meeting point, and wherein optionally, said solid, monolithic, spherical plug is sized and adapted to fit in said cylindrical portion and to engage said shoulder.

10. The photovoltaic cell of any one of claims 1 to 8, wherein said solid, monolithic, spherical plug is sized and adapted to fit and to lodge completely within, said frusto-conical portion.

11. The photovoltaic cell of any one of claims 7 to 10, wherein each of said cylindrical portion and said frusto-conical portion has a depth in the range of 0.1-2 mm.

12. The photovoltaic cell of any one of claims 7 to 11, wherein each of a first depth of said cylindrical portion and a second depth of said frusto-conical portion is in the range of 20%-80% of a depth of said hole.

13. The photovoltaic cell of any one of claims 1 to 12, wherein a thickness of said curable sealant layer is within a range of 0.05-1 mm, and/or within a range of 20%-80% of a depth of said hole.

14. The photovoltaic cell of any one of claims 1 to 13, said at least one curable sealant layer primarily containing a UV curable silicone-based sealant, or said at least one curable sealant layer primarily containing a thermally curable and optionally fusible sealant, wherein said thermally curable sealant optionally comprises a thermally curable epoxy sealant or a thermally curable silicone-based sealant, and wherein said thermally curable sealant optionally has a curing temperature in the range of 60 to 100° C.

15. The photovoltaic cell of any one of claims 1 to 14, said at least one curable sealant layer comprising an inner curable sealant layer and an outer curable sealant layer, the outer curable sealant layer being sealed from the interior of said cell.

16. The photovoltaic cell of claim 15, said outer curable sealant layer primarily containing an epoxy sealant and said inner curable sealant layer primarily containing a silicone-based sealant.

17. The photovoltaic cell of claim 16, said inner sealant layer sealing between said outer sealant layer and said porous support layer, such that components of said epoxy sealant are inhibited from contacting said porous support layer.

18. The photovoltaic cell of any one of claims 15 to 17, said outer curable sealant layer being disposed between said solid, monolithic, spherical plug and said exterior face, and said inner curable sealant layer being disposed between said solid, monolithic, spherical plug and said interior face.

19. The photovoltaic cell of any one of claims 15 to 17, said outer curable sealant layer being disposed between said exterior face and said inner curable sealant layer, and said inner curable sealant layer being disposed between said outer curable sealant layer and said solid, monolithic, spherical plug.

20. The photovoltaic cell of any one of claims 15 to 19, a thickness of said outer curable sealant layer being within a range of 0.05-1 mm, and/or a thickness of said inner curable sealant layer being within a range of 0.05-1 mm.

21. The photovoltaic cell of any one of claims 15 to 20, a thickness of said outer curable sealant layer being within a range of 20%-80% of a depth of said hole, and/or a thickness of said inner curable sealant layer being within a range of 20%-80% of a depth of said hole.

22. The photovoltaic cell of any one of claims 1 to 21, said sealing arrangement adapted to inhibit oxygen and water vapor from an environment external to the photovoltaic cell, from penetrating into the photovoltaic cell via said hole and contacting said porous support layer.

23. The photovoltaic cell of any one of claims 1 to 22, wherein a thickness of said cell wall including said hole is in the range of 0.3-3.2 mm.

24. The photovoltaic cell of any one of claims 1 to 23, the photovoltaic cell having a minimum footprint of 0.5 cm by 2 cm, 0.5 cm by 5 cm, 1 cm by 5 cm, 5 cm by 5 cm, 7 cm by 7 cm, 10 cm by 10 cm, 12 cm by 12 cm, or 15 cm by 15 cm, and optionally, a maximum footprint of 50 cm by 50 cm or 35 cm by 35 cm.

25. The photovoltaic cell of any one of claims 1 to 24, said hole and said sealing arrangement disposed on a cathodic side or within the cathodic wall of the photovoltaic cell, or within a non-transparent wall of the photovoltaic cell.
